(19) United States
(12) Patent Application Publication
(10) Pub. No.: US 2015/0279202 A1
(43) Pub. Date: Oct. 1, 2015

(54) Universal Remote Control

(71) Applicant: THE CHAMBERLAIN GROUP, INC., ELMHURST, IL (US)

(72) Inventor: James J. Fitzgibbon, Batavia, IL (US)

(73) Assignee: THE CHAMBERLAIN GROUP, INC., ELMHURST, IL (US)

(21) Appl. No.: 14/228,837

(22) Filed: Mar. 28, 2014

(51) Int. Cl. G08C 17/02; G07C 9/00

(52) U.S. Cl. CPC G08C 17/02; G07C 9/00896; G08C 2201/92; G08C 2201/20; G07C 2009/00928

(57) ABSTRACT

A movable barrier operator remote control is provided having a receiver configured to receive a signal from another remote control, a user input of a control interface, a memory, a transmitter, and a controller. The controller automatically both senses for the receiver receiving a signal and senses for a status of at least a portion of the control interface, and associates with the user input one or more movable barrier operator signal characteristics from the received signal or the status of the at least a portion of the control interface. A remote control is also provided having a controller configured to detect the configuration of a switch input, sense for a receiver receiving a signal in response to the switch input having a first configuration, and sense for a status of at least a portion of a control interface in response to the switch input having a second configuration.

### FIELD

The field relates to remote controls and, more particularly, universal remote controls for movable barrier operators.

### BACKGROUND

Movable barrier operators may be used to control access to areas by moving movable barriers between different positions. Various types of movable barriers can be moved in such a fashion, including vertically moving barriers such as single piece and segmented barriers as well as horizontally moving barriers such as sliding and swinging gates.

Remote controls are often used to operate movable barrier operators. In some instances, it may be desired to add a remote control for use with a particular movable barrier operator or to replace a lost or broken remote control for the movable barrier operator. Various manufacturers sell universal remote controls that can emulate an existing remote control such that a user can program the universal remote control to work with the movable barrier operator. For example, a user may have a first vehicle with a first remote control for activating a garage door opener and later purchases a second vehicle that requires a second remote control for activating the garage door opener. With an emulation-type universal remote control, the user can program the universal remote control by placing the universal remote control in a learn mode and causing the first remote control to transmit a signal. The universal remote control detects properties of the signal and configures its transmitter to emulate the signal from the first remote control. The universal remote control can then be used to activate the garage door opener.

### BRIEF DESCRIPTION OF THE DRAWINGS

FIG. 1 is a perspective view of a movable barrier operator and remote control in accordance with one embodiment of the present disclosure;

FIG. 2 is a schematic view of a remote control in accordance with one embodiment of the present disclosure;

FIGS. 3-5 are flow charts of an example process in accordance with one embodiment of the present disclosure;

FIGS. 6A, 6B, and 7 are flow charts of example sub-processes of the process of FIGS. 3-5 in accordance with various embodiments of the present disclosure;

FIG. 8 is a schematic view of a remote control in accordance with another embodiment of the present disclosure;

FIGS. 9-13 are flow charts of an example process in accordance with another embodiment of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

It has been realized that conventional universal remote controls for movable barrier operators are inconvenient in some circumstances. For example, although emulation-type universal remote controls are well-suited for utilization as an additional remote control for controlling a movable barrier operator, a customer may not be able to utilize an emulation-type universal remote control if the previous remote control has been lost or broken. In these instances, manufacturers sell programmable remote controls that permit a user to manually program the universal remote control to communicate with the movable barrier operator. One type of programmable universal remote control are remote controls with dual in-line package (DIP) switches that are set to a particular configuration which represents, for example, a particular manufacturer of the movable barrier operator (e.g., Genie or Chamberlain) and a particular transmission frequency (e.g., 310, 315, or 390 kHz). Another type of programmable universal remote control allows the user to select the configuration from a list of known remote types by pressing and releasing a button of the remote control a number of times in order to select a particular configuration.

A buyer who desires to add or replace a remote control is therefore expected to appreciate the differences between emulation-type and programmable universal remote controls and select the appropriate universal remote control for his or her particular situation. The buyer may not appreciate these differences and select a remote control that is difficult to program given his or her particular situation, e.g., selecting an emulation-type universal remote control to replace a lost or broken remote control. This experience can engender ill will toward the manufacturer or retailer, because the buyer will need to exchange the inappropriate universal remote control for one that more closely matches the buyer's situation. The universal remote control described herein solves this and other problems as well as provides improved ease of use and greater applicability than conventional universal remote controls.

In one aspect, a movable barrier operator remote control is provided that can be quickly and easily used to replace a lost or broken remote control or added to one or more existing remote controls for operating a movable barrier operator. The remote control includes a receiver configured to receive a signal from another remote control, a transmitter, a control interface, a user input of the control interface, and a memory configured to store one or more signal characteristics for a movable barrier operator. The remote control further includes a controller configured to, during a learning mode of operation, automatically both: 1) sense for the receiver receiving a signal having one or more movable barrier operator signal characteristics; and 2) sense for a status of at least a portion of the control interface corresponding to one or more movable barrier operator signal characteristics. This allows the remote control to learn the one or more movable barrier operator signal characteristics by receiving information via a signal from the receiver (emulation-type learning) or from the status of the at least a portion of the control interface (programmable-type learning). Stated differently, by automatically sensing for both the receiver receiving a signal and for a status of the at least a portion of the control interface during the learning mode, the remote control can detect the one or more movable barrier signal characteristics whether the characteristics are being transmitted to the remote control from another remote or are being communicated via the status of the control interface. It is intended that the term “automatically” as used herein encompass operations that do not require user intervention in order to perform the operation. In one embodiment, once the remote control is placed in the learning mode the controller monitors the receiver for receipt of a signal and stores one or more characteristics of the signal if the signal is received within a period of time after the remote control has entered the learning mode. If a signal is not received at the receiver within the period of time, the controller stores one or more characteristics of a signal corresponding to the status of the at least a portion of the control interface.

The controller is further configured to, during the learning mode of operation, associate with the user input the one or more movable barrier operator signal characteristics from the received signal or the status of the at least a portion of the control interface. The remote control thereby provides an easy-to-use learning mode wherein the controller determines the one or more movable barrier operator signal characteristics based on the information the user provides, whether the information is obtained from the receiver or from the control interface. Thus, the remote control eliminates the need for a buyer to determine and correctly select a particular type of universal remote control for his or her particular application because the remote control is suitable for a broader range of applications than some conventional universal remote controls.

In another aspect, a movable barrier operator remote control is provided that can be trained by, depending on the position of a switch input of the remote control, emulating a signal from another remote control or by user programming. More specifically, the remote control has a transmitter, a control interface, a user input of the control interface, a switch input having a plurality of configurations, and a memory configured to store one or more signal characteristics for a movable barrier operator. The remote control further has a controller operably coupled to the receiver, the transmitter, the control interface, the switch input, and the memory. The controller is configured to detect a configuration of the switch input and sense for the receiver receiving a signal having one or more movable barrier operator signal characteristics in response to the controller detecting the switch having a first configuration. The controller is further configured to sense for a status of a user input corresponding to one or more movable barrier operator signal characteristics in response to the controller detecting the switch input having a second configuration. The controller associates with the user input the one or more movable barrier operator signal characteristics from the received signal or the status of the at least a portion of the control interface. In this manner, a user can actively select the programming mode for the remote control transmitter, which improves the user experience by allowing the user to select a programming regime narrowly tailored to the user's particular circumstances. In one form, the movable barrier operator remote control has a learning mode and the controller is configured to detect the configuration of the switch input and sense for the receiver receiving a signal or sense for a status of a user input during the learning mode. The use of a learning mode permits the user to appreciate that the remote control is ready to be programmed and the switch input should be put in a desired configuration in order to program the remote control.

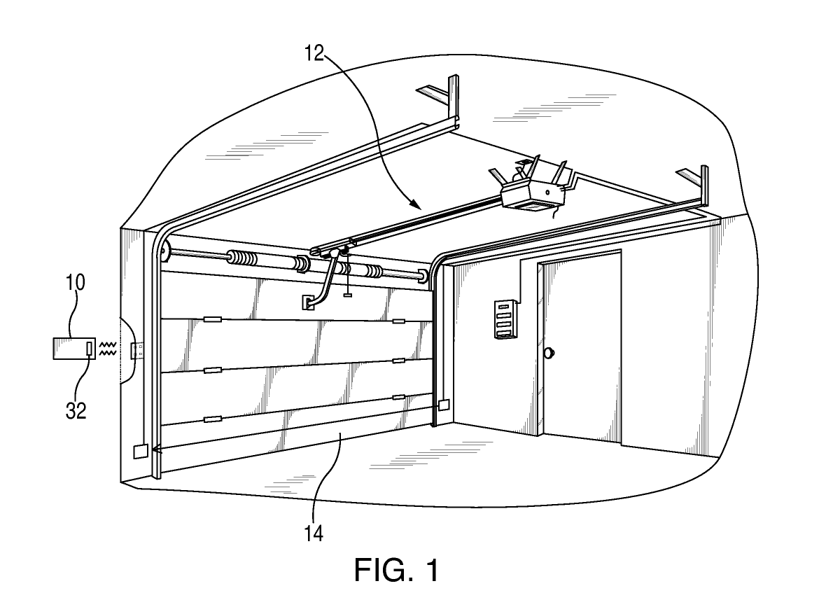

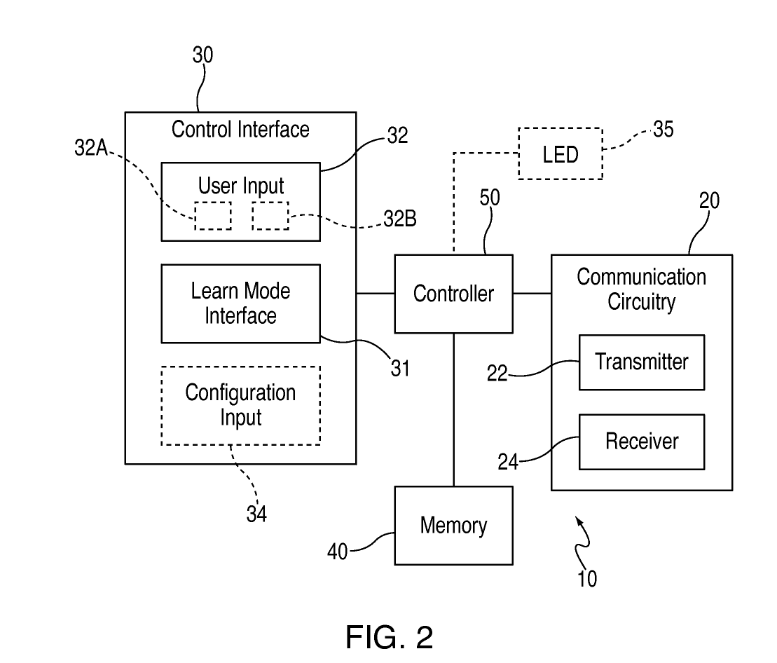

With reference to FIGS. 1 and 2, a universal remote control 10 for operating a movable barrier operator 12 and producing associated movement of a movable barrier 14 is shown. The remote control 10 has communication circuitry 20 including a transmitter 22 and a receiver 24 that, in one form, are contained on a single integrated circuit board. The remote control 10 has a control interface 30 that may be used to interact with the remote control 10 and a memory for storing one or more signal characteristics of one or more movable barrier operators. The one or more signal characteristics may be accessed in response to a manipulation of a user input 32 of the control interface 30. The control interface 30 may take a variety of forms, including having a learning mode control interface 31 and a signal configuration input 34 in addition to the user input 32. In one form, the learning mode control interface 31 and user input 32 includes pushbuttons and the configuration input 34 includes DIP switches. It will be appreciated that some components of the remote control 10 may be similar to off-the-shelf components. For example, the transmitter 22, receiver 24, and user input 32 of the remote control 10 may be similar to components in a Universal Remote Control, Model 375 LM, sold under the Liftmaster® brand name. As another example, the control interface 30 may utilize a display with various icons and user-adjustable indicia for the learning mode control interface 31, user input 32, and configuration input 34. The configuration input 34 in this display embodiment may have a field that receives alphanumeric values corresponding to one or more signal characteristics. In yet another approach, one or more of the learning mode control interface 31, user input 32, and configuration input 34 are configured to receive voice commands from a user.

The remote control 10 further includes a controller 50 operably coupled to the transmitter 22, the receiver 24, the control interface 30, and the memory 40. The controller 50 is configured to operate the transmitter 22 and receiver 24, as well as control data transfer to and from the memory 40. For example, the controller 50 may be configured to adjust the transmitter 22 to transmit at a particular frequency with a particular security code according to one or more movable barrier operator signal characteristics stored in the memory 40. With respect to the receiver 24, the controller 40 is configured to determine one or more movable barrier operator signal characteristics from a signal received at the receiver 24, such as a signal from another remote control previously programmed to operate the movable barrier operator 12.

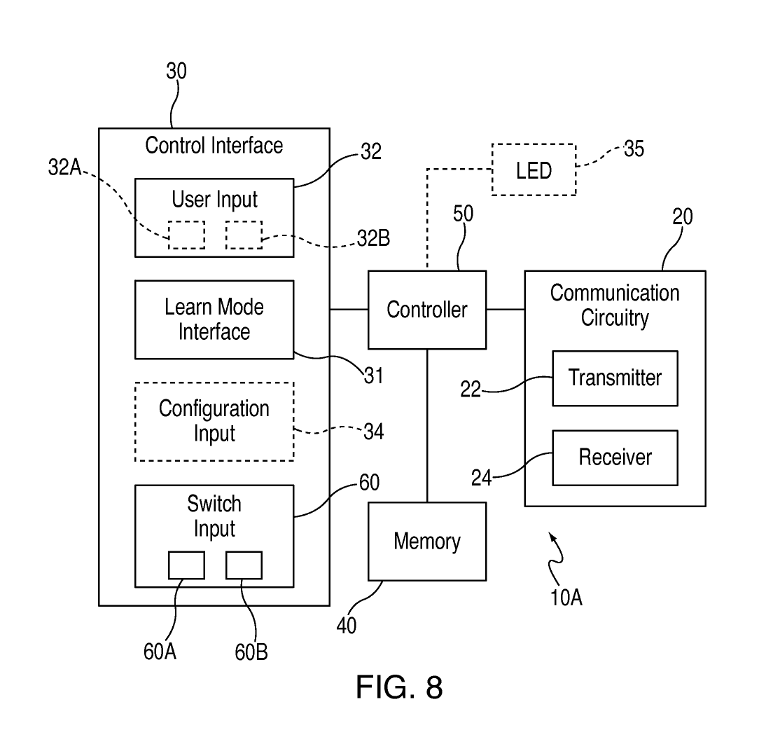

With reference to FIG. 8, another remote control 10A is provided that is similar to the remote control 10 with similar components being indicated with similar reference numerals. The remote control 10A, however, has a control interface 30 that includes a switch input 60 and the controller 50 is configured to sense a configuration of the switch input 60. As discussed in greater detail below, the configuration of the switch input 60 can allow a user to program the remote control 10A using a technique associated with a particular configuration of the switch input 60. For example, the switch input 60 may be a two position switch with a first position corresponding to emulation-type programming of the remote control and a second position corresponding to user-type programming of the remote control. A user can thereby train the remote control 10A by setting the switch input 60 to the corresponding configuration and providing the appropriate information to the remote control 10A.

As another example, the switch input 60 may have two push buttons 60A, 60B that are respectively associated with emulation-type programming and programmable-type learning. To program the remote control 10A, a user presses the button 60A which reconfigures the switch input 60 to a first position. This causes the controller 50 to sense for the receiver 24 receiving a signal having one or more movable barrier operator signal characteristics. Alternatively, the user presses the button 60B which reconfigures the switch input 60 to a second position. This causes the controller 50 to sense for a status of at least a portion of the control interface 30. The operation of the switch input 60 is discussed in greater detail below with respect to FIGS. 8-13.

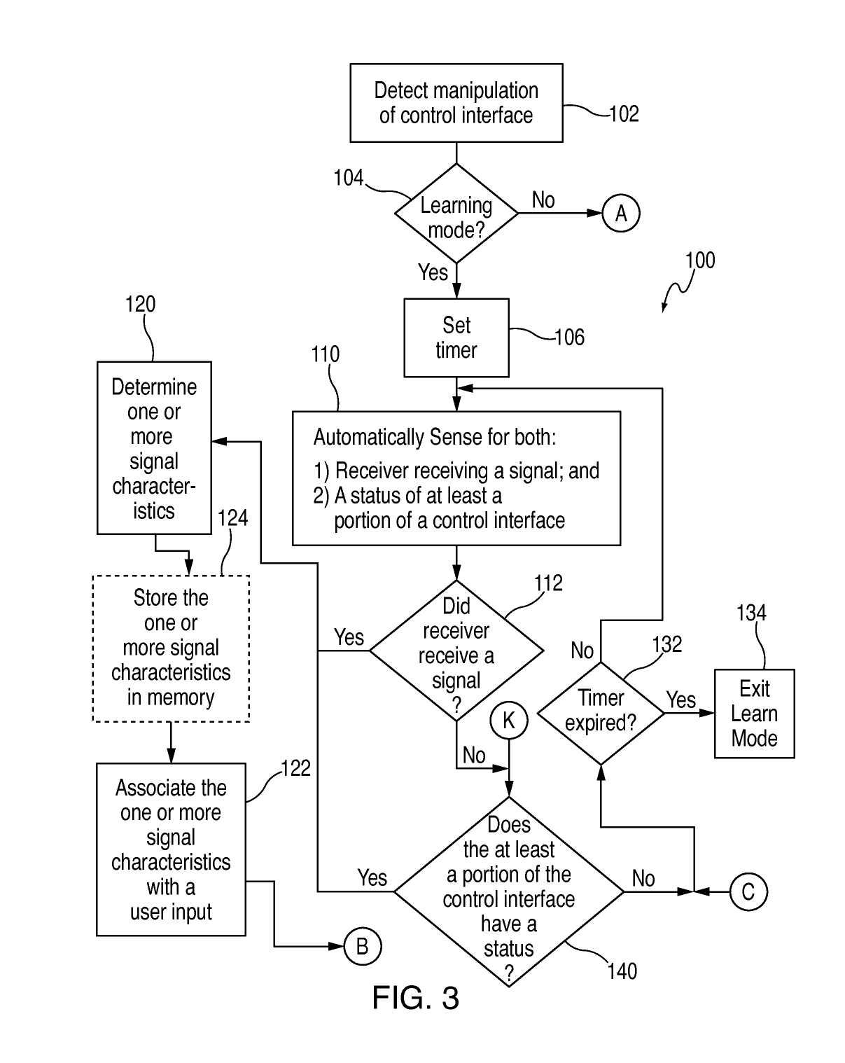

Turning to FIGS. 3-5, an example process 100 of operating the remote control 10 is shown. The process 100 may begin with the controller 50 being in an operating mode and detecting 102 manipulation of at least a portion of the control interface 30, such as the user pressing a pushbutton of the learning mode control interface 31 to initiate the learning mode of the remote control 10. As another example, the configuration input 34 may include DIP switches that can be set to a particular configuration to initiate the learning mode of the remote control 10.

The controller 50 determines 104 whether to enter a learning mode or to remain in its operating mode. If the controller 50 enters 104 the learning mode, the controller 50 may set a time limit for the learning mode by setting 106 a timer.

The controller 50 then automatically senses 110 for both the receiver 24 receiving a signal, such as a transmission from another remote control, and a status of at least a portion of the control interface 30. To sense for the receiver 24 receiving a signal, the controller 50 in one form monitors an output of the receiver 24 to observe whether the receiver 24 has received a transmitted radio signal.

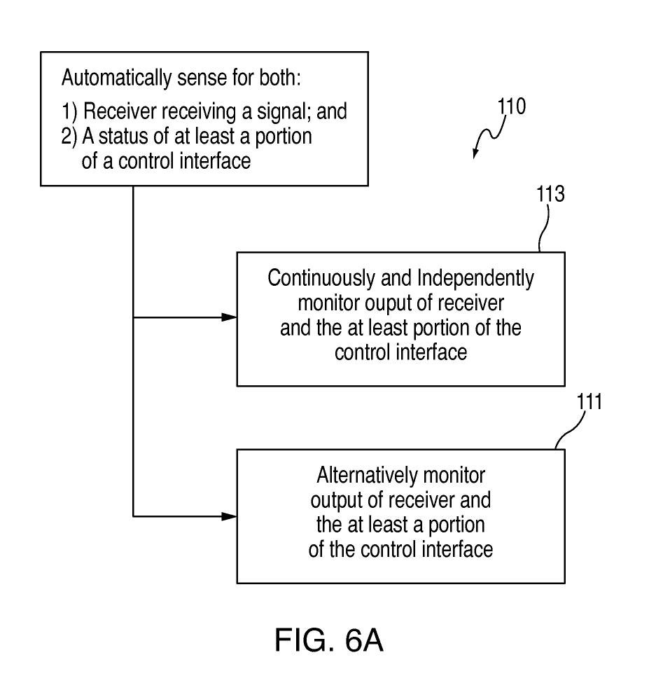

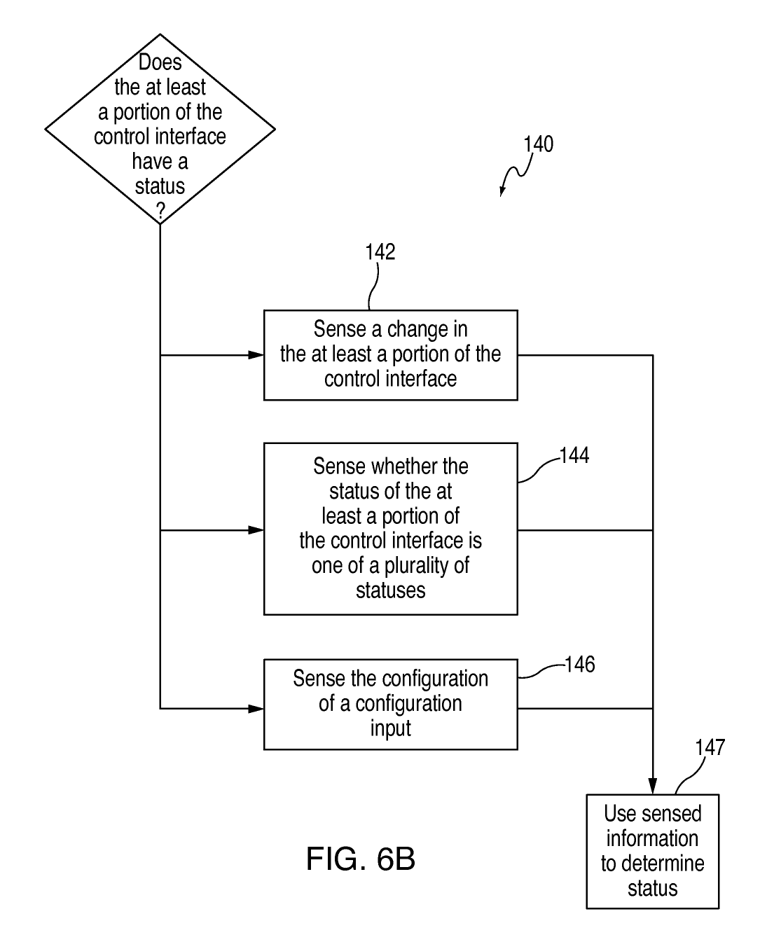

The controller 50 can employ a variety of approaches for sensing a status of the at least a portion of the control interface 30 of the remote control 10, as discussed in greater detail with respect to FIG. 6. At this point, it is sufficient to note that sensing the status of the at least a portion of the control interface 30 can include sensing a change in the at least a portion of the control interface 30, such as a change in position of a pushbutton of the user input 32. As another example, sensing the status of the at least a portion of the control interface 30 can include sensing the configuration of the signal configuration input 34, which may be DIP switches.

The controller 50 may automatically sense 110 for both the receiver 24 receiving a signal and the status of the user input 30 in a number of ways. With momentary reference to FIG. 6A, the controller 50 may utilize a polling technique whereby the controller 50 alternatively monitors 111 the output of the receiver 24 for an indication of a signal and then senses the at least a portion of the control interface 30. The controller 50 repeats the process of alternatively monitoring the output of the receiver 24 and monitoring the at least a portion of the control interface 30 until the controller 50 detects the receiver 24 receiving enough of a signal in order to identify one or more signal characteristics or the controller 50 detects the status of the at least a portion of the control interface 30 having a status that identifies one or more signal characteristics. In another approach, the controller 50 uses an interrupt technique whereby the controller 50 continuously and independently monitors 113 the output of the receiver 24 and the at least a portion of the control interface 30 at the same time.

Referring again to FIG. 3, next, the controller 50 determines 112 whether the receiver 24 received a signal. If the receiver 24 has not received a signal, the controller 50 proceeds to check 140 whether the at least a portion of the control interface 30 has a status, as discussed in greater detail below. If the receiver 24 has received a signal, the controller 50 uses information from the receiver 24 to determine 120 one or more movable barrier operator signal characteristics of the received signal. Examples of the one or more signal characteristics include frequency, amplitude, a security code, code length, code type (fixed or rolling), and encryption methodology.

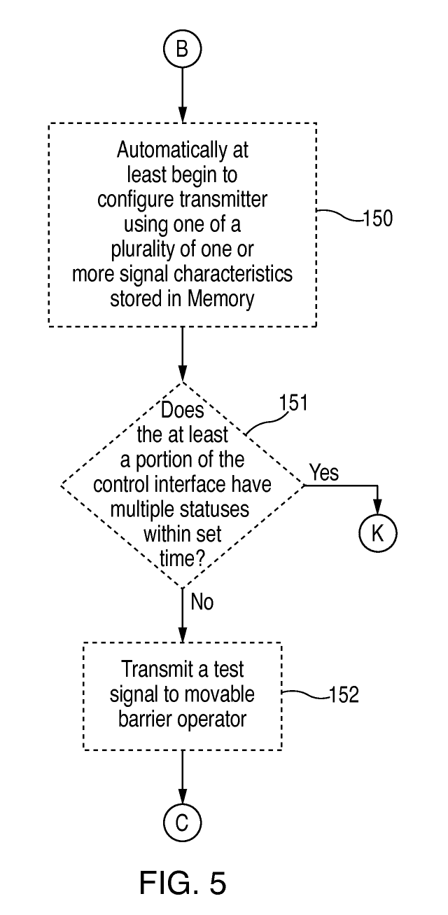

Optionally, the controller 50 may store 124 the one or more movable barrier operator signal characteristics in the memory 40. In another approach, the one or more signal characteristics are already stored in the memory 40, and the specific signal characteristics are selected according to the stored memory location using, for example, the user input 32 as discussed in greater detail below with respect to FIGS. 3 and 5.

The controller 50 then associates 122 the one or more movable barrier operator signal characteristics with the user input 32. The controller 50 may associate 122 the one or more movable barrier operator signal characteristics with the user input 32 by prompting the user to manipulate the user input 32 before, during, or after the receiver 24 receives the signal from the other remote control.

For example, a user may press a button of the learning mode control interface 31 on the remote control 10 to cause the remote control 10 to enter the learning mode 104. The user then uses an existing remote control to transmit a movable barrier operator control signal to the receiver 24 (which is sensed at step 110), permits the controller 50 to store one or more signal characteristics of the sensed signal in memory 40, and then manipulates the user input 32 such that the controller 50 associates the one or more signal characteristics with the user input 32.

As illustrated in optional steps 150-152 in FIG. 5, the controller 50 can configure the transmitter 22 and transmit a test signal to the movable barrier operator 12 in order to permit the user to determine whether the remote control 10 is correctly programmed, as discussed in greater detail below.

Returning to FIG. 3, the controller 50 next checks 132 whether the timer has expired. If so, the controller 50 exits 134 the learning mode and the remote control 10 returns to its operating mode. Although a relatively simple timer is illustrated, it will be appreciated that many different approaches could be utilized to limit the duration of the learning mode such as a counter that tracks the number of times the controller 50 senses 110 whether the receiver 24 has received a signal and/or senses the status of the at least a portion of the control input 30.

In one form, the user input 32 has two or more user input devices 32A, 32B that include respective pushbuttons. A user can sequentially program the remote control 10 to transmit different signals in response to actuation of the different user inputs 32 by using the following procedure. Initially, the user causes the remote control 10 to enter 104 the learning mode and transmits a signal from a first remote control to the receiver 24. The controller 50 senses 110 the signal, determines 120 one or more characteristics of the received signal, and stores 124 the one or more signal characteristics in the memory 40. The controller 50 prompts the user using a light emitting diode (LED) 35 (see FIG. 2) to manipulate the first user input device 32A, which the controller 50 then associates 122 with one or more signal characteristics of the signal from the first remote control. Before the timer 106 expires, the user transmits a second signal to the receiver 24 from a second remote control. The controller 50 senses 110 the second signal, determines 122 one or more characteristics of the second received signal, and stores 124 the one or more signal characteristics in the memory 40. The controller 50 prompts the user to manipulate the second user input device 32B, which the controller then associates 122 with the one or more signal characteristics of the signal from the second remote control. In this manner, the remote control 10 can be sequentially programmed to emulate signals from different remote controls by using iterations through the process 100 and without exiting the learning mode 104.

As noted above, the controller 50 senses 110 for both the receiver 24 receiving a signal and a status of at least a portion of the control interface 30. If the controller 50 determines 112 that the receiver 24 has not received a signal, the controller determines 140 whether the at least a portion of the control interface 30 has a status, as discussed below.

The control interface 30 can take a variety of forms including one or more buttons, multi-position switches, icons on a graphic user interface, etc. With reference to FIG. 6B, the determination 140 of whether the at least a portion of the control interface 30 has a status can, for example, include sensing 142 for a change in the at least a portion of the control interface 30, sensing 144 whether the status of the at least a portion of the control interface 30 is one of a plurality of different statuses, and sensing 146 the configuration of the configuration input 34. One or more of these approaches 142, 144, 146 may be used to determine whether the at least a portion of the control interface 30 has a particular status. The controller 50 uses 147 the sensed information to determine the status of the at least a portion of the control interface 30.

With reference to FIG. 3, if the controller determines 140 that the at least a portion of the control interface 30 has a status, the controller 50 determines 120 one or more signal characteristics, may store 124 the one or more signal characteristics, and associates 122 the one or more movable barrier signal characteristics with the user input 32. As one example, the user input 32 includes a pushbutton, and the configuration input 34 includes DIP switches. The controller 50 senses 146 the configuration of the DIP switches, determines 120 one or more signal characteristics defined by the DIP switch configuration, and then associates 122 the pushbutton of the user control interface 32 with the one or more signal characteristics.

As another example, the user input 32 includes one or more pushbuttons, and the controller 50 associates 122 one or more movable barrier operator signal characteristics with the one or more pushbuttons by permitting a user to index through a plurality of one or more movable barrier operator signal characteristics stored in the memory 40, as shown in FIGS. 3 and 5. In this form, a user can program the remote control 10 by causing the controller 50 to enter 104 the learning mode and manipulating the user input 32, which causes the controller 50 to associate 122 the user input 32 with one or more movable barrier operator signal characteristics at a first index position in the memory 40. The controller 50 may then automatically at least begin to configure 150 the transmitter 22 using the one or more movable barrier operator signal characteristics at the first index position in the memory 40. In one form, the remote control 10 detects 151 a user repeatedly manipulating the user input 32 within a set time, such as repeated pressing of a pushbutton of the user input 32, to quickly index through the one or more movable barrier operator signal characteristics stored in the memory 40 without having to at least begin to configure 150 the transmitter 22 with the one or more signal characteristics for each index position in the memory 40, as discussed below.

If the controller 50 does not detect 151 multiple statuses within the set time, the controller 50 causes the transmitter 22 to transmit 152 a test signal to the movable barrier operator 12. If the movable barrier operator 12 begins to operate and move the movable barrier 14, the user can appreciate that the remote control 10 is now programmed to operate the movable barrier operator 12. If the movable barrier operator 12 does not operate in response to the test signal transmitted at step 152, the user can again manipulate the user input 32, such as by pressing the pushbutton again, which is sensed 110 by the controller 50 as shown in FIG. 3. The controller 50 then determines 120 that it should associate 122 the one or more movable barrier operator signal characteristics at the second index position stored in the memory 40 with the user input 32, which has now been manipulated twice. The controller 50 then automatically at least begins to configure 150 the transmitter 22 using the one or more signal characteristics stored at the second index position in the memory 40 and transmits 152 a test signal to the movable barrier operator 12 as shown in FIG. 5. This process can continue until the transmitted 152 test signal activates the movable barrier operator 12 such that the user knows that the remote control 10 is programmed to operate the movable barrier operator 12 and stops pressing the pushbutton of the user input 32.

If the controller 50 detects 151 multiple statuses of the user input 32 within the set time, the controller 50 skips transmitting 152 the test signal and returns to checking 140 the status of the at least a portion of the control interface. The at least a portion of the control interface 30, such as a pushbutton of the user input 32, having another status within the set time period therefore causes the controller 50 to advance to the one or more movable barrier operator signal characteristics at the second index position in the memory 40 without transmitting 152 the test signal associated with the one or more movable barrier operator signal characteristics at the first index position.

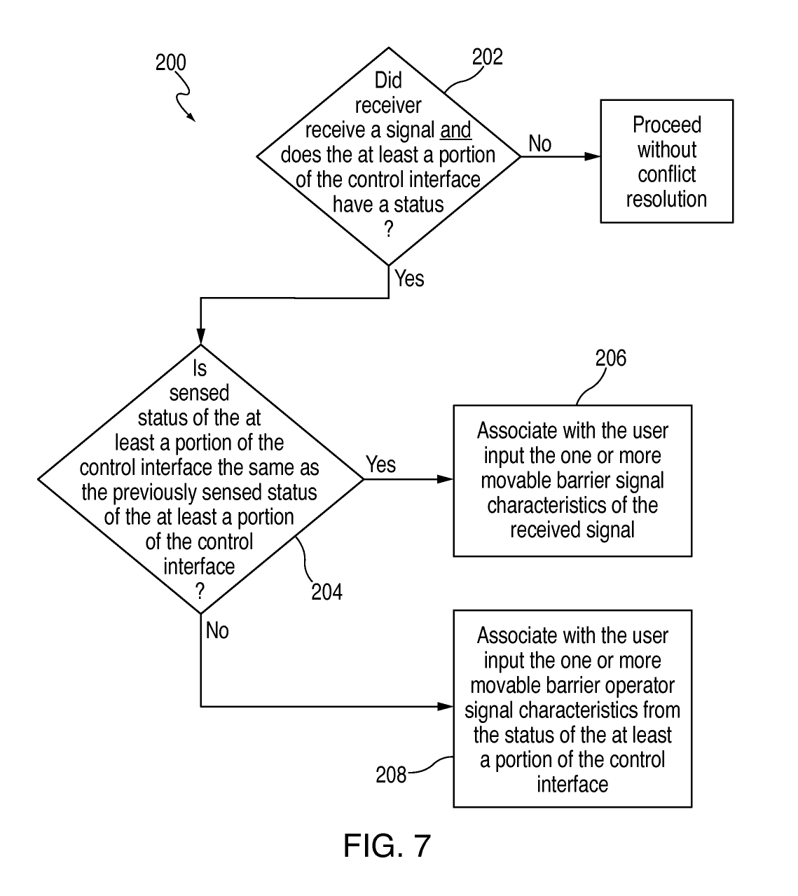

In some instances, the controller 50 may sense 110 both the receiver 24 receiving a signal and sense a status of the at least a portion of the control interface 30. For example, the configuration input 34 may include DIP switches that permit a user to program the remote control 10. The user may have previously programmed signal characteristics using the DIP switches and associated those signal characteristics with a user input 32, but now wishes to associate the user input 32 with a signal from another remote control via the receiver 24. In other words, the user wishes to program over the one or more signal characteristics for the user input 32 that were previously programmed using DIP switches of the configuration input 34. With reference to FIG. 7, the process 100 can include a conflict resolution process 200 that addresses this type of situation.

The conflict resolution process 200 begins with the controller 50 determining 202 whether the receiver 24 received a signal and whether the at least a portion of the control interface 30 has a status. If this occurs, the controller 50 determines 204 whether the sensed status of the at least a portion of the control interface 30, in this example the previously configured DIP switches of configuration input 34, is the same as the previously sensed status of the at least a portion of the control interface 30. Stated differently, the controller 50 in this example is determining 204 whether the configuration of the DIP switches of the configuration input 34 remains unchanged from the last time the controller 50 sensed 110 the configuration input 34.

If the controller 50 determines that the status of the at least a portion of the control interface 30 (in this example the configuration input 34) is the same as the previously sensed status, the controller 50 associates 206 the one or more movable barrier operator signal characteristics of the received signal (received at the receiver 24, sensed at step 110, and determined at step 120) with the user input 32. Alternatively, if the sensed status of the at least a portion of the control interface 30 is different, the process 200 assigns priority to the sensed status of the at least a portion of the control interface 30 and associates 208 the user input 32 with the one or more movable barrier operator signal characteristics from the status of the at least a portion of the configuration input 30 (e.g., the status of the configuration input 34 determined at step 120). Thus, the foregoing example prioritizes a “new” status of the at least a portion of the control interface 30 over a signal received at the receiver 24. It will be appreciated that many different conflict resolution mechanisms may be devised, and that one or more conflict resolution mechanisms can be utilized in the remote control. As another example the system may automatically record the one or more signal characteristics defined by the configuration interface 34 after a period if no radio signal is received at the receiver 24. As but one further example in this regard, the controller 50 may be programmed to prioritize, determine 120, store 124, and associate 122 one or more signal characteristics of a signal sensed 110 at the receiver 24 regardless of the status of the at least a portion of the control interface 30 sensed at step 110.

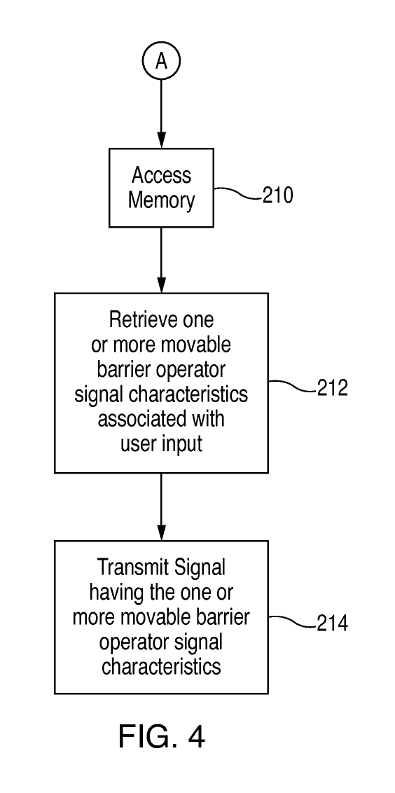

With reference again to FIGS. 3 and 4, a user may utilize the remote control 10 to operate the movable barrier operator 12 once the controller 50 has associated 122 the one or more movable barrier signal characteristics with the user input 32 and exited 134 the learning mode. For example, the user may press a pushbutton of the user input 32 that causes the controller 50 to access 210 the memory 40 rather than enter 104 the learning mode, as shown in FIGS. 3 and 4. The controller 50 retrieves 212 the one or more movable barrier operator signal characteristics associated with the user input 32 from the memory 40 and causes the transmitter 22 to transmit 214 a signal having the one or more movable barrier operator signal characteristics.

It will be appreciated that the process 100 provides an easy-to-use approach for programming the remote control 10 including associating the user input 32 of the remote control 10 with one or more movable barrier operator signal characteristics received from different sources (e.g., via the receiver 24, the user input 32, and the configuration input 34). If the user input 32 includes multiple inputs, the process 100 also permits the user to quickly and easily program the remote control 10 to associate each one of the inputs with corresponding one or more movable barrier operator signal characteristics from the same or different sources.

For example, the user input 32 may include two user input devices 32A, 32B (see FIG. 2), such as pushbuttons, and the signal configuration input 34 may include DIP switches. A user can program the user input device 32A to operate a first movable barrier operator in the user's home and can program the second user input device 32B to operate a second movable barrier operator in the user's home. To program the first user input device 32A to operate the first movable barrier operator, the user sets the DIP switches of the configuration input 34 to a configuration that defines one or more movable barrier operator signal characteristics for the first movable barrier operator. Next, the user causes the controller 50 to enter 104 the learning mode and the controller 50 senses 110 that the at least a portion of the control interface 30 has a status, which in this example is a configuration of the DIP switches of the configuration input 34. The controller 50 determines 120 the one or more signal characteristics from the DIP switches and associates 122 the one or more signal characteristics with the first user input device 32A. In this example, the operation of the controller 50 associating 122 the one or more signal characteristics from the DIP switches of the configuration input 34 with the push button of the user input device 32A includes the controller 50 activating the LED 35 of the remote control 10. The LED 35 alerts the user that he can manipulate the user input 32 in order to associate the push button of the user input device 32A (which is part of the user input 32) with the one or more signal characteristics defined by the DIP switches. The user then presses the push button of the user input device 32A, and the controller 50 completes its association 122 of the one or more signal characteristics from the DIP switches of the configuration input 34 with the pushbutton of the user input device 32A.

Next, the user can program the remote controller 10 to associate the pushbutton of the second user input device 32B with one or more movable barrier operator signal characteristics using a different input process and without exiting the learning mode. One example of such an application is if the user desires to set the remote control 10 to operate like an existing remote control that operates the second movable barrier operator. With reference to FIG. 3, the user causes the existing remote control to transmit a signal to the receiver 24 of the remote control 10. The controller 50 senses 110 the receiver 24 receiving the signal, determines 120 the one or more signal characteristics of the received signal, and stores 124 the one or more signal characteristics in the memory 40. The controller 50 associates 122 the one or more signal characteristics with the pushbutton of the second user input device 32B including activating the LED 35 to prompt the user to manipulate the user input 32 and complete the association 122. In this manner, the user can sequentially associate the pushbutton of the first user input device 32A with one or more signal characteristics defined by the DIP switches of the configuration input 34 and then associate the second user input device 32B with one or more signal characteristics of a signal received by the receiver 24.

As another example, the user input 32 has two user input devices 32A, 32B with respective pushbuttons and the signal configuration input 34 has DIP switches. The user could associate the first user input device 32A with the one or more movable barrier operator signal characteristics defined by the DIP switches generally as described in the previous example with reference to FIG. 3. However, instead of associating the second user input device 32B with one or more movable barrier operator signal characteristics from a signal received by the receiver 24, the user may associate 122 one or more movable barrier operator signal characteristics with the second user input device 32B by pressing the push button of the second user input device 32B and causing the controller 50 to index through one or more signal characteristics stored in the memory 40, as described above with respect to FIGS. 3 and 5. The remote control 10 thereby provides an intuitive and easy-to-use programming operation for programming the remote control 10 to operate two or more movable barrier operators based on information from the same or different sources.

With reference to FIGS. 8-13, the remote control 10A includes the switch input 60 and may be programmed to operate the movable barrier operator 12 according to a process 300. Once the remote control 10A has been programmed according to the process 300, the controller 50 may be configured to cause the transmitter 22 to transmit an operate signal in response to manipulation of the user input 32. The process 300 is similar to the process 100 described above such that differences between the processes 100, 300 will be highlighted. The controller 50 detects 304 the configuration of the switch input 60 and determines 306 whether the switch input 60 has a configuration. The detecting 304 of the switch input 60 configuration may cause the controller 50 to proceed with the process 300 in response to the controller 50 detecting that the switch input 60 has a predetermined configuration, such as the switch 60 being reconfigured to a position marked “emulate” on an exterior surface of the remote control 10A. In another approach, the remote control 10A first enters 302 a learning mode (such as in response to user manipulation of the learning mode control interface 31) before detecting 304 the configuration of the switch input 60 and the controller 50 sets 303 a learning mode timer after entering 302 the learning mode.

The switch input 60 may be a two-position switch having first and second configurations, and the controller 50 initially determines 306 whether the switch input 60 is in a first configuration. (As discussed above, the switch input 60 may alternatively have buttons 60A, 60B that a user manipulates to set the switch input 60 to the first configuration or the second configuration.) If the switch input 60 is in the first configuration, the controller 50 sets 309 a training timer, senses 310 for the receiver 24 receiving a signal, determines 311 whether a signal was received, and determines 312 one or more movable barrier operator signal characteristics of the signal in a manner similar to the sensing 110, determining 112, and determining 120 described above with respect to process 100. The controller 50 stores 313 the one or more signal characteristics in the memory 40 in a manner similar to the storing 124 discussed above with respect to FIG. 3.

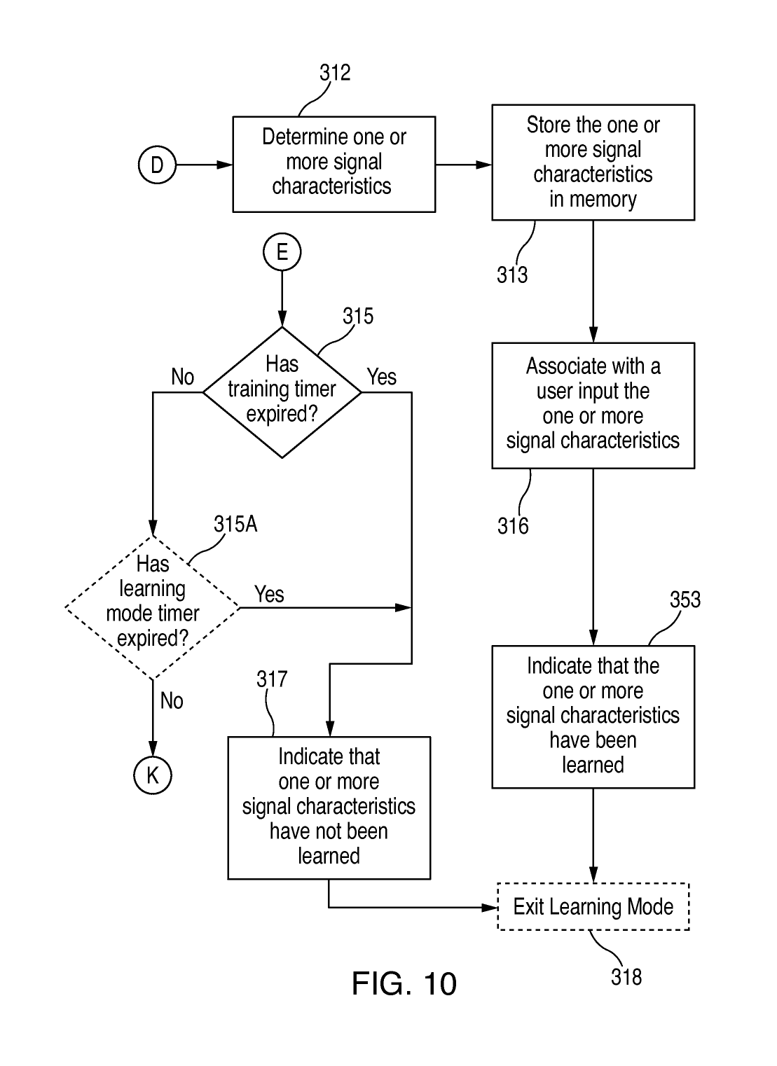

As shown in FIG. 10, the controller 50 can then associate 316 the user input 30 with the one or more movable barrier operator signal characteristics in a manner similar to the associating 122 described above with respect to process 100. The controller 50 indicates 353 that one or more signal characteristics have been learned and exits 318 the learning mode (if utilized).

If the controller 50 determines 311 that a signal was not received by the receiver 24, the controller 50 checks 315 whether the training timer has expired. The controller 50 may also check 315A whether the learning mode timer has expired. If either timer has expired, the controller 50 indicates 317 that one more signal characteristics have not been learned, such as by illuminating an LED on the remote control 10A. Alternatively, if the training timer and the learning mode timer have not expired, the controller 50 returns to sensing 310 for the receiver 24 receiving a signal.

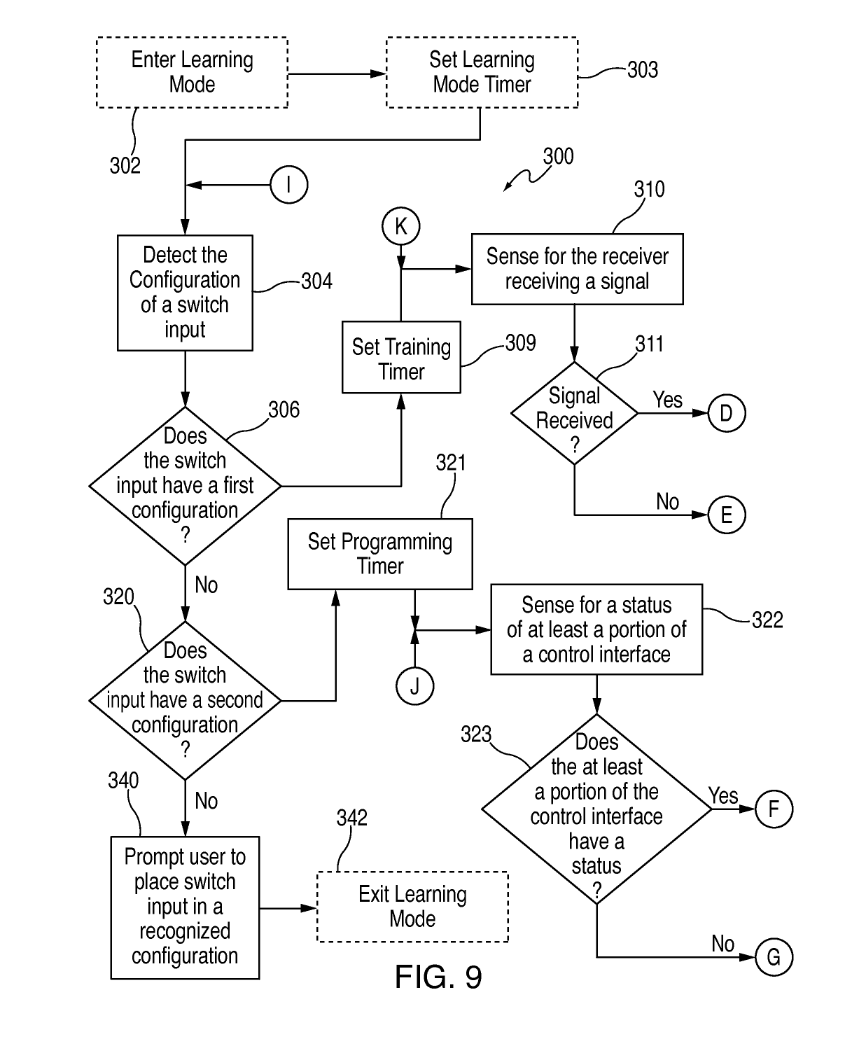

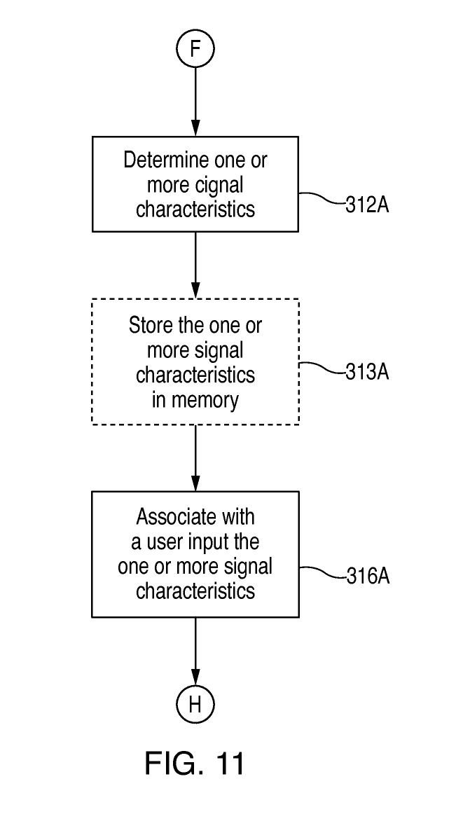

If the controller 50 determines 320 that the switch input 60 is in a second configuration, the controller 50 sets 321 (see FIG. 9) a programming timer, senses 322 for a status of at least a portion of the control interface 30, determines 323 whether the at least a portion of the control interface 30 has a status, determines 312A (see FIG. 11) one or more movable barrier operator signal characteristics, optionally stores 313A the one or more signal characteristics in memory, and associates 316A a user input with the one or more signal characteristics in a manner similar to the operations described above with respect to process 100.

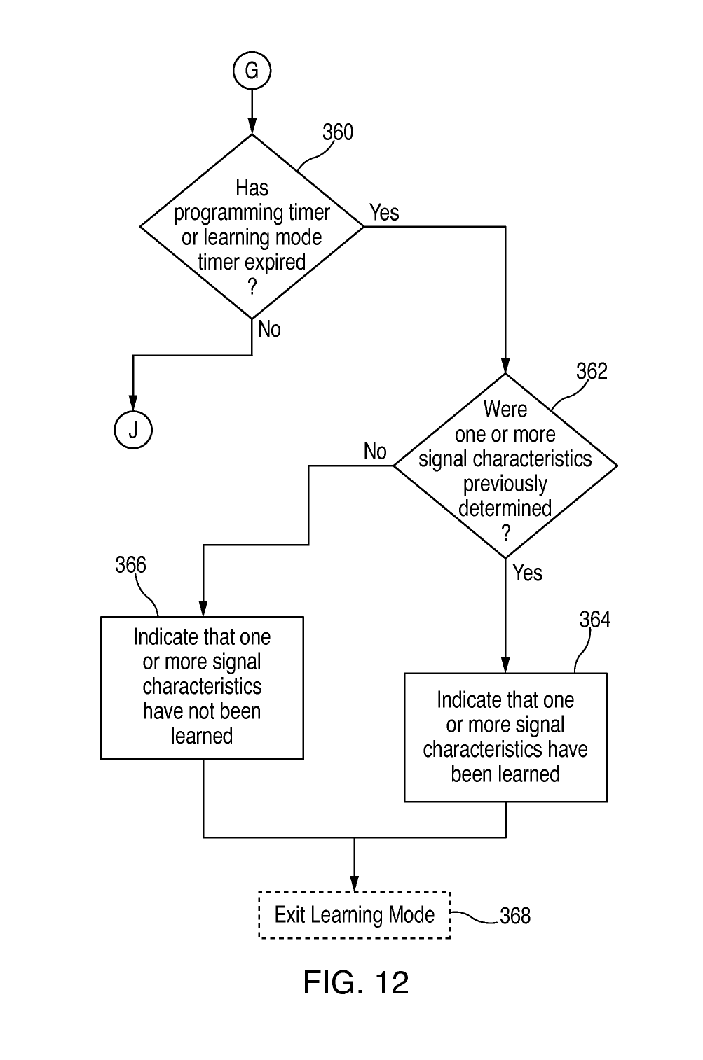

If the controller 50 determines 323 that the at least a portion of the control interface 30 does not have a status, the controller 50 checks 360 whether the programming timer or learning mode timer (if a learning mode is utilized) has expired (see FIG. 12). If the programming timer and learning mode timers have not yet expired, the controller 50 again senses 322 for a status of the at least a portion of the control interface 30. If the programming timer or the learning mode timer has expired at step 360, the controller determines 362 whether one or more signal characteristics were previously determined, such as during a previous iteration of the steps 322, 323, 312A, 313A, and 316. If so, the controller 50 indicates 364 that one or more signal characteristics have been learned. This scenario may occur before expiration of the programming timer but after the user has indexed through movable barrier signal characteristics stored in the memory 40 and has found the one or more signal characteristics that operate the target movable barrier operator. If the controller determines 362 that one or more signal characteristics have not previously been learned, the controller 50 indicates 366 this result such as by activating an LED of the remote control 10. The controller 50 may then exit 368 the learning mode, if utilized.

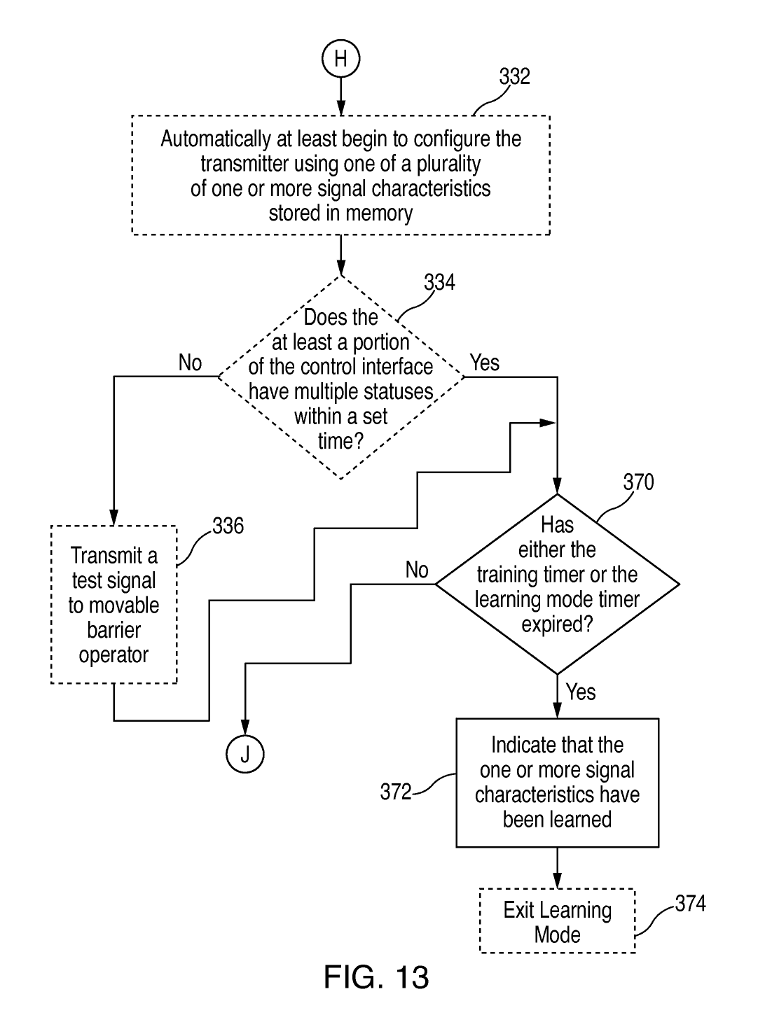

Like the process 100, the process 300 permits a user to index through stored one or more movable barrier operator signal characteristics stored in the memory 40 and associate a user input 32 with one of the stored one or more movable barrier operator signal characteristics, as described above with respect to process 100. For example and with reference to FIGS. 9 and 11-13, if the controller 50 determines 320 that the switch input 60 has the second configuration, the controller 50 may sense 322 for a status of the at least a portion of the control interface 30, determine 323 whether the at least a portion of the control interface 30 has a status, determine 312A one or more movable barrier operator signal characteristics stored at a first index position in the memory 40, and associate 316A the one or more movable barrier operator signal characteristics with the user input 30. With reference to FIG. 13, the controller 50 may automatically at least begin to configure 332 the transmitter 22 using the one or more signal characteristics stored at the first index position in the memory 40. In one form, the remote control 10A detects 334 for multiple statuses of the at least a portion of the control interface 30 within a set time, such as repeated pressing of a push button of the user input 32, to quickly index through the one or more movable barrier operator signal characteristics stored in the memory 40 in a manner similar to the operation 151 discussed above with respect to FIG. 5. If the controller 50 does not detect 334 the multiple statuses of the user input 30, the controller 50 may cause the transmitter 22 to transmit 336 a test signal to the movable barrier operator 12 and permit the user to observe whether the movable barrier operator 12 begins to operate.

Next, the controller 50 determines 370 whether the training timer or the learning mode timer (if utilized) has expired. If either the programming timer or the learning mode timer has expired, the controller 50 indicates 372 that one or more signal characteristics have been learned followed by exiting 374 the learning mode (if utilized). If the programming timer and the learning mode timer have not yet expired, the controller 50 again senses 322 for a status of the at least a portion of the control interface 30 and the process continues.

With reference to FIG. 9, the controller 50 may optionally prompt 340 the user to place the switch input 60 in a recognized configuration and exit 342 the learning mode in the event the controller 50 determines 306, 320 that the switch input 60 is not in either the first configuration or the second configuration.

The described embodiments are therefore to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A movable barrier operator remote control comprising:
a receiver configured to receive a signal from another remote control for operating a movable barrier operator;
a transmitter;
a control interface;
a user input of the control interface;
a memory configured to store one or more signal characteristics for a movable barrier operator;
a controller operably coupled to the receiver, the transmitter, the control interface, and the memory, the controller being configured to:
during a learning mode of operation:
automatically both sense for the receiver receiving a signal having one or more movable barrier operator signal characteristics and sense for a status of at least a portion of the control interface corresponding to one or more movable barrier operator signal characteristics; and
associate with the user input the one or more movable barrier operator signal characteristics from the received signal or the status of the at least a portion of the control interface.

2. The remote control of claim 1 wherein the status of the at least a portion of the control interface corresponding to the one or more movable barrier operator signal characteristics comprises a change in the at least a portion of the control interface.

3. The remote control of claim 1 wherein the status of the at least a portion of the control interface corresponding to the one or more movable barrier operator signal characteristics comprises one of a plurality of different statuses of the at least a portion of the control interface.

4. The remote control of claim 1 wherein the controller is configured to cause the transmitter to transmit an operate signal having the one or more movable barrier operator signal characteristics in response to manipulation of the user input once the controller has exited the learning mode of operation.

5. The remote control of claim 1 wherein the at least a portion of the control interface includes the user input and the memory has stored therein a plurality of one or more signal characteristics for a plurality of movable barrier operators and the controller is configured to automatically at least begin to configure the transmitter during the learning mode using one of the plurality of programmed one or more signal characteristics with user manipulation of the user input to provide a test configured transmitter.

6. The remote control of claim 5 wherein the controller is configured to cause the test configured transmitter to transmit a test signal during the learning mode of operation to thereby permit the user to ascertain whether a corresponding movable barrier operator responds positively to the test configured transmitter.

7. The remote control of claim 1 wherein the at least a portion of the control interface includes a configuration input configured to be set to a predetermined configuration to define the one or more movable barrier operator signal characteristics.

8. The remote control of claim 7 wherein the configuration input comprises a plurality of switches and the controller is configured to determine the one or more movable barrier signal characteristics defined by the signal configuration input based at least in part on the positions of the switches.

9. The remote control of claim 7 wherein the controller is configured to cause the transmitter to transmit an operate signal having the one or more movable barrier operator signal characteristics in response to assertion of the user input.

10. The remote control of claim 1 wherein the receiver, transmitter, memory, and controller are disposed on a single integrated circuit.

11. A movable barrier operator remote control comprising:
a receiver configured to receive a signal from another remote control for operating a movable barrier operator;
a transmitter;
a control interface;
a user input of the control interface;
a switch input of the control interface having a plurality of configurations;
a memory configured to store one or more signal characteristics for a movable barrier operator;
a controller operably coupled to the receiver, the transmitter, the control interface, and the memory, the controller being configured to:
detect the configuration of the switch input;
sense for the receiver receiving a signal having one or more movable barrier operator signal characteristics in response to the controller detecting the switch input having a first configuration;
sense for a status of at least a portion of the control interface corresponding to one or more movable barrier operator signal characteristics in response to the controller detecting the switch input having a second configuration; and
associate with the user input the one or more movable barrier operator signal characteristics from the received signal or the status of the at least a portion of the control interface.

12. The remote control of claim 11 wherein the status of the at least a portion of the control interface corresponding to one or more movable barrier operator signal characteristics comprises a change in the at least a portion of the user input.

13. The remote control of claim 11 wherein the status of the control interface corresponding to the one or more movable barrier operator signal characteristics comprises one of a plurality of different statuses of the at least a portion of the control interface.

14. The remote control of claim 11 wherein the switch input comprises a multi-position switch with different positions corresponding to the first and second configurations.

15. The remote control of claim 11 wherein the controller has a learning mode and the controller is configured to detect the configuration of the switch input and sense for the receiver receiving a signal or sense for a status of the at least a portion of the control interface during the learning mode.

16. The remote control of claim 11 wherein the controller is configured to automatically detect the configuration of the switch input and sense for the receiver receiving a signal or sense for a status of the at least a portion of the control interface.

17. The remote control of claim 11 wherein the controller is configured to cause the transmitter to transmit an operate signal having the one or more movable barrier operator signal characteristics in response to manipulation of the user input.

18. The remote control of claim 11 wherein the at least a portion of the control interface includes the user input and the memory has stored therein a plurality of one or more signal characteristics for a plurality of movable barrier operators and the controller is configured to automatically at least begin to configure the transmitter using one of the plurality of programmed one or more signal characteristics with each user manipulation of the user input to provide a test configured transmitter.

19. The remote control of claim 11 wherein the at least a portion of the control interface includes a configuration input configured to be set to a predetermined configuration to define the one or more movable barrier operator signal characteristics.

20. The remote control of claim 19 wherein the controller is configured to cause the transmitter to transmit an operate signal having the one or more movable barrier operator signal characteristics in response to assertion of the user input.

21. A method of operating a movable barrier operator remote control, the method comprising:
at the remote control:
entering a learning mode of operation;
automatically both sensing for a receiver of the remote control receiving a signal having one or more movable barrier operator characteristics and sensing for a status of at least a portion of a control interface of the remote control corresponding to one or more movable barrier operator signal characteristics; and
associating with a user input of the control interface the one or more movable barrier operator signal characteristics from the received signal or the status of the at least a portion of the control interface.

22. The method of claim 21 wherein sensing for the status of the at least a portion of the control interface comprises sensing for a change in the at least a portion of the control interface.

23. The method of claim 21 wherein sensing for the status of the at least a portion of the control interface comprises sensing for the at least a portion of the control interface having one of a plurality of different statuses.

24. The method of claim 21 further comprising:
exiting the learning mode; and
transmitting an operate signal having the one or more movable barrier operator signal characteristics in response to manipulation of the user input.

25. The method of claim 21 wherein sensing for the status of the at least a portion of the control interface includes sensing for the status of the user input; and
during the learning mode:
automatically at least begin to configure a transmitter of the remote control using one of a plurality of one or more signal characteristics stored in a memory of the remote control in response to a user manipulation of the user input.

26. The method of claim 25 further comprising:
during the learning mode:
transmitting a test signal to permit the user to ascertain whether a corresponding movable barrier operator responds positively to the test signal.

27. The method of claim 21 wherein sensing for the status of the at least a portion of the control interface comprises sensing the configuration of a configuration input of the control interface which defines the one or more movable barrier operator signal characteristics.

28. The method of claim 21 further comprising transmitting with a transmitter of the remote control an operate signal having the one or more movable barrier operator signal characteristics in response to assertion of the user input.

29. The method of claim 21 wherein associating with the user input the one or more movable barrier operator signal characteristics includes associating with a first user input device of the user input the one or more movable barrier operator signal characteristics from one of the received signal or the status of the at least a portion of the control interface; and
without exiting the learning mode:
automatically both sensing for the receiver of the remote control receiving a signal having one or more movable barrier operator characteristics and sensing for the status of the at least a portion of the control interface corresponding to one or more movable barrier operator signal characteristics; and
associating with a second user input device of the user input the one or more movable barrier operator signal characteristics from the received signal or the status of the at least a portion of the control interface.

30. The method of claim 21 wherein associating with the user input the one or more movable barrier operator signal characteristics includes storing the one or more movable barrier operator signal characteristics in a memory of the remote control.

31. A method of operating a movable barrier operator remote control, the method comprising:
at the remote control:
detecting a configuration of a switch input of a control interface of the remote control;
sensing for a receiver of the remote control receiving a signal having one or more movable barrier operator signal characteristics in response to detecting the switch input having a first configuration;
sensing for a status of a portion of the control interface corresponding to one or more movable barrier operator signal characteristics in response to detecting the switch input having a second configuration; and
associating with a user input of the control interface the one or more movable barrier operator signal characteristics from the received signal or the status of the at least a portion of the control interface.

32. The method of claim 31 wherein sensing for the status of the at least a portion of the control interface comprises sensing for a change in the at least a portion of the control interface.

33. The method of claim 31 wherein sensing for the status of the at least a portion of the control interface comprises sensing for one of a plurality of different statuses of the at least a portion of the control interface.

34. The method of claim 31 further comprising entering a learning mode; and
sensing for the receiver of the remote control receiving a signal or sensing for the status of the at least a portion of the control interface comprises sensing during the learning mode.

35. The method of claim 31 further comprising automatically detecting the configuration of the switch input and sensing for the receiver receiving a signal or sensing for a status of the at least a portion of the control interface.

36. The method of claim 31 further comprising transmitting an operate signal having the one or more movable barrier operator signal characteristics from a transmitter of the remote control in response to manipulation of the user input.

37. The method of claim 31 further comprising automatically at least beginning to configure a transmitter of the remote control using one of a plurality of one or more signal characteristics stored in a memory of the remote control in response to a user manipulation of the user input.

38. The method of claim 31 wherein sensing for the status of the at least a portion of the control interface comprises sensing the configuration of a configuration input which defines the one or more movable barrier operator signal characteristics.

39. The method of claim 31 further comprising transmitting with a transmitter of the remote control an operate signal having the one or more movable barrier operator signal characteristics in response to assertion of the user input.
